(19) United States
(12) Patent Application Publication
(10) Pub. No.: US 2026/0268091 A1
(43) Pub. Date: Sep. 10, 2026

(54) LARGE LANGUAGE MODEL INFERRED CAUSAL CONFOUNDER GENERATION

(71) Applicant: Microsoft Technology Licensing, LLC, Redmond, WA (US)

(72) Inventors: Kaashyap Thiyagaraj MURALIEDHARAN, Redmond, WA (US); Gorkem Ozer YILMAZ, Redmond, WA (US); Avleen Singh BIJRAL, Redmond, WA (US)

(73) Assignee: Microsoft Technology Licensing, LLC, Redmond, WA (US)

(21) Appl. No.: 19/073,169

(22) Filed: Mar. 7, 2025

(51) Int. Cl. G06F 40/40; G06F 9/54

(52) U.S. Cl. CPC G06F 40/40; G06F 9/544

(57) ABSTRACT

A data processing system implements analyzing input data from analytics platform using a large language model to cause the model to analyze the metadata and generate a list of causal confounders that may influence a causal relationship between an independent variable and an output being studied; generating a plurality of causal hypothesis scenarios testing how one or more causal confounders of the list of causal confounders influence a relationship between the independent variable and the output being studied; executing the plurality of causal hypothesis scenarios to obtain causal inference results; performing statistical testing on the causal results to determine whether each confounder of the list of causal confounders satisfies a significance threshold; pruning the list of causal confounders to remove confounders that do not satisfy the significance threshold; and generating a report that identifies each of the confounders and includes a description of a significance of each of the confounders.

### BACKGROUND

In the realm of data-driven decision-making, comprehending customer behavior and conducting experiments to enhance product features is paramount. Causal Inference seeks to enable the analyst by providing answers to questions about how specific changes or interventions impact outcomes. For example, it can help determine whether a new marketing strategy increases sales, if a product feature improves user engagement, or how different pricing models affect customer retention. Traditional methods for causal inference often require extensive manual selection of confounders and feature engineering, which can be time-consuming, require specialized domain and/or statistical knowledge, and are prone to human error. Also, existing tools lack seamless integration with popular analytics platforms, limiting their accessibility and usability for business analysts and data scientists. Hence, there is a need for improved systems and methods that provide a technical solution to automatically test and validate multiple causal hypotheses end-to-end in analytics tools.

### SUMMARY

An example data processing system according to the disclosure includes a processor and a memory storing executable instructions. The instructions when executed cause the processor alone or in combination with other processors to perform operations including receiving input data from an analytics platform, the input data including metadata associated with the input data that describes characteristics and properties of the input data; constructing a prompt to a large language model based on the metadata, the prompt instructing the large language model to analyze the metadata and generate a list of candidate causal confounders that may influence a causal relationship between an independent variable and an output being studied; providing the prompt as an input to the large language model to obtain the list of candidate causal confounders; generating a plurality of causal hypothesis scenarios, each causal hypothesis scenario testing how one or more causal confounders of the list of candidate causal confounders influence a relationship between the independent variable and the output being studied; executing the plurality of causal hypothesis scenarios to obtain causal inference results; performing statistical testing on the causal inference results to determine whether each confounder of the list of candidate causal confounders satisfies a significance threshold; iteratively pruning the list of candidate causal confounders to remove confounders that do not satisfy the significance threshold to generate a pruned list of causal confounders; and generating a report based on the pruned list of causal confounders that identifies each of the confounders and includes a description of a significance of each of the confounders.

An example method implemented in a data processing system includes receiving input data from an analytics platform, the input data including metadata associated with the input data that describes characteristics and properties of the input data; constructing a prompt to a large language model based on the metadata, the prompt instructing the large language model to analyze the metadata and generate a list of candidate causal confounders that may influence a causal relationship between an independent variable and an output being studied; providing the prompt as an input to the large language model to obtain the list of candidate causal confounders; generating a plurality of causal hypothesis scenarios, each causal hypothesis scenario testing how one or more causal confounders of the list of candidate causal confounders influence a relationship between the independent variable and the output being studied; executing the plurality of causal hypothesis scenarios to obtain causal inference results; performing statistical testing on the causal inference results to determine whether each confounder of the list of candidate causal confounders satisfies a significance threshold; iteratively pruning the list of candidate causal confounders to remove confounders that do not satisfy the significance threshold to generate a pruned list of causal confounders; and generating a report based on the pruned list of causal confounders that identifies each of the confounders and includes a description of a significance of each of the confounders.

An example machine-readable medium on which are stored instructions that, when executed, cause a processor of alone or in combination with other processors to perform operations of receiving input data from an analytics platform, the input data including metadata associated with the input data that describes characteristics and properties of the input data; constructing a prompt to a large language model based on the metadata, the prompt instructing the large language model to analyze the metadata and generate a list of candidate causal confounders that may influence a causal relationship between an independent variable and an output being studied; providing the prompt as an input to the large language model to obtain the list of candidate causal confounders; generating a plurality of causal hypothesis scenarios, each causal hypothesis scenario testing how one or more causal confounders of the list of candidate causal confounders influence a relationship between the independent variable and the output being studied; executing the plurality of causal hypothesis scenarios to obtain causal inference results; performing statistical testing on the causal inference results to determine whether each confounder of the list of candidate causal confounders satisfies a significance threshold; iteratively pruning the list of candidate causal confounders to remove confounders that do not satisfy the significance threshold to generate a pruned list of causal confounders; and generating a report based on the pruned list of causal confounders that identifies each of the confounders and includes a description of a significance of each of the confounders.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example process for automatically identifying causal confounders from data obtained from an analytics platform.

FIG. 2 is a diagram of an example automated confounder generation framework that can implement the process shown in FIG. 1.

FIG. 3 is a diagram of example metadata obtained from an analytics platform.

FIG. 4A is a diagram of an example prompt generated by the automated confounder generation framework to instruct a large language model to analyze the metadata to generate list of confounders.

FIG. 4B is a diagram of an example prompt template used to generate the example prompt shown in FIG. 4A.

FIG. 5A is a diagram of an example novel confounders and higher order confounders generated in response to the prompt shown in FIG. 4A and the metadata shown in FIG. 3.

FIG. 5B is a diagram of an example report generated by the automated confounder generation framework.

FIG. 6 is a diagram of an example computing environment in which the automated confounder generation framework is implemented according to the disclosure.

FIG. 7 is a flow chart of an example process for automatically identifying causal confounders according to the techniques disclosed herein.

FIG. 8 is a block diagram showing an example software architecture, various portions of which may be used in conjunction with various hardware architectures herein described, which may implement any of the described features.

FIG. 9 is a block diagram showing components of an example machine configured to read instructions from a machine-readable medium and perform any of the features described herein.

### DETAILED DESCRIPTION

Systems and methods for automatically identifying causal confounders are provided. Causal inference is a process of determining how changes to a particular independent variable (also referred to herein as a “cause”) impact a dependent variable (also referred to herein as an “outcome”). Understanding how changes to the independent variable impact an outcome being studied can help predict future outcomes. Therefore, causal inference provides a useful tool that is widely used in a number of domains, including but not limited to healthcare, economics, marketing, product development, epidemiology, and numerous other domains in which understanding the cause-and-effect relationships is critical.

Causal confounders (also referred to herein as “confounding factors” or “confounders”) are variables that influence both the independent variable and the outcome being studied. Causal confounders can distort the perceived cause-and-effect relationship between the independent variable and the outcome. Consequently, failure to identify and account for the influence of causal confounders can result in incorrect inferences between drawn regarding the relationship between the independent variables and the outcome.

Identifying causal confounders is a non-trivial exercise. Current approaches to causal inference typical require manual identification of the causal confounders, which is a laborious, manual, and error-prone process that requires specialized domain and/or statistical knowledge. The techniques provided herein provide a technical solution to the problem of identifying causal confounders with an automated confounder generation framework that analyzes data to identify causal confounders that are likely to influence a causal analysis performed on that data. The automated confounder generation framework can integrate directly with an analytics platform to enable users to perform causal analysis and identify confounders in the analytics data directly from the analytics platform.

The automated confounder generation framework leverages the analytical ability of a large language model to analyze the data available in the analytics platform facilitate causal analysis by identifying the causal confounders that influence the data being analyzed. The automated confounder generation framework utilizes the large language model to generate a list of confounders based on the input data and associated metadata received from the analytics platform. The automated confounder generation framework analyzes this list of confounders to perform feature generation based on the list of confounders generated by the large language model to associate values with the confounders included on the list of confounders. The automated confounder generation framework then formulates multiple causal hypotheses based on the list of confounders to test the influence of each of these confounders on the output. Each causal hypothesis represents a potential causal relationship between an independent variable and the outcome and considers different sets of one or more causal confounders that can influence this relationship. The automated confounder generation framework then tests the multiple causal hypotheses using various causal inference methods. The automated confounder generation framework evaluates each causal confounder for significance using significance testing and prunes the list of confounders to include only that have a substantial impact on the causal estimates. The refined list of confounders forms the final set of confounders to be used in the causal analysis. The automated confounder generation framework can then repeat the above process to perform feature engineering to generate higher-order features which are combinations or transformations of the original confounders. The automated confounder generation framework also performs significance testing for these higher-order features and prunes the list of higher-order features so that only the most relevant features are included in the causal model. A technical benefit of this approach is that the automated confounder generation framework facilitates more efficient utilization of computing, energy, and water resources by automatically identifying confounders in analytics data rather than relying on a manual trial and error approach that is error prone and can result in causal inference testing to be repeated numerous times to try to identify the causal relationships and confounders influencing these relationships.

Another technical benefit of the automated confounder generation framework is that the automated confounder generation framework integrates directly with the analytics platform. Current causal inference tools typically operate as standalone operations, which requires users to export data from their primary analytics platform, process it separately in the causal inference tools, and then import the results back into the analytics platform. This workflow is cumbersome and manually intensive. The automated confounder generation framework provided herein implements a technical solution to this problem by integrating directly with the analytics platform, providing users with a seamless workflow that integrates the advanced data analytics techniques of the automated confounder generation framework into a preferred analytics platform. A technical benefit of this approach is that integrating the automated confounder generation framework with the analytics platform can significantly reduce computing, network, energy, and water resources that would be required to move data between the analytics platform and the causal analysis tools provided by the automated confounder generation framework. These and other technical benefits of the techniques disclosed herein will be evident from the discussion of the example implementations that follow.

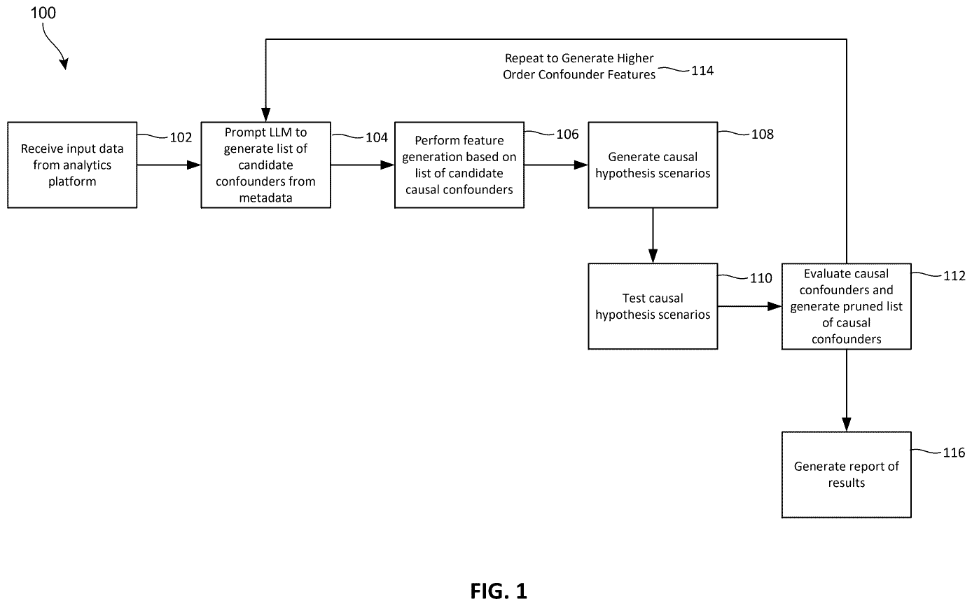

FIG. 1 is a diagram of an example process 100 for automatically identifying causal confounders from data obtained from an analytics platform. The example process 100 can be implemented by the automated confounder generation framework disclosed herein. The automated confounder generation framework can be integrated with various analytics platforms. The analytics platform can provide interactive data visualization tools that focus on business intelligence. Business intelligence, as used herein, refers to systems and methods for data analysis and management of business information. The analytics platform can provide tools that include but are not limited to inputting data, analyzing data, performing various types of calculations on the data, and generating reports and/or visualizations of the data.

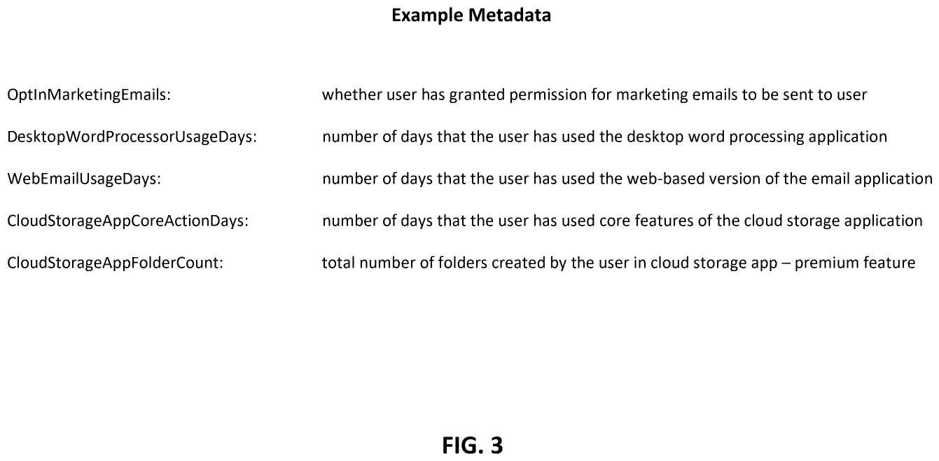

In operation 102, the automated confounder generation framework receives input data from an analytics platform. Current causal inference tools are typically standalone applications that require the user to export the data from the analytics platform, import the data into the causal inference tools, perform causal analysis on the data, export the results from the causal inference tools, and import the results from the causal inference tool back into the analytics platform. A technical problem with this approach is that the user workflow is interrupted, and the manual process is subject to human error. The automated confounder generation framework provides a technical solution to this problem by integrating directly with the analytics platform. In some implementations, the automated confounder generation framework provides an add-on or extension that integrates the functionality of the automated confounder generation framework with the analytics platform. This includes the addition of controls to a user interface of the analytics platform that enable the user to cause the automated confounder generation framework to analyze the data from the analytics platform. The data is provided as an input to the automated confounder generation framework. The analytics platform also provides metadata data that describes the data provided to the automated confounder generation framework. The metadata describes the characteristics and properties of the input data from the analytics platform. These characteristics and properties include a structure of the input data. The data can include various types of data on which causal analysis is to be performed. In a non-limiting example, the data includes customer demographics information, sales figures, product usage information, and/or other such information associated with a product suite offered by an enterprise, and the metadata includes a description of each of these data values. The data values included in the metadata can be considered as potential causal confounders to be tested by the automated confounder generation framework. FIG. 3 provides a non-limiting example of the metadata included with the data obtained from the analytics platform. The specific types of metadata included depends on the data being analyzed in the analytics platform and is not limited to the specific example shown in FIG. 3. In this example the OptInMarketingEmails, DesktopWordProcessorUsageDays, WebEmailUsageDays, CloudStorageAppCoreActionDays, and CloudStorageAppFolderCount included in the metadata are considered as possible causal confounders by the automated confounder generation framework.

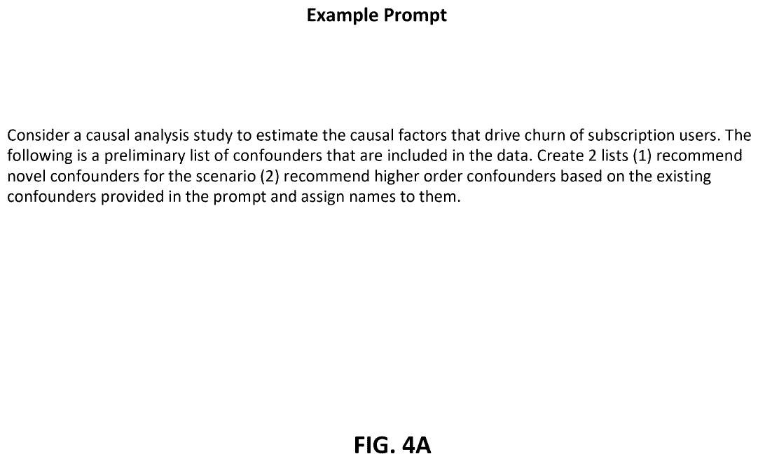

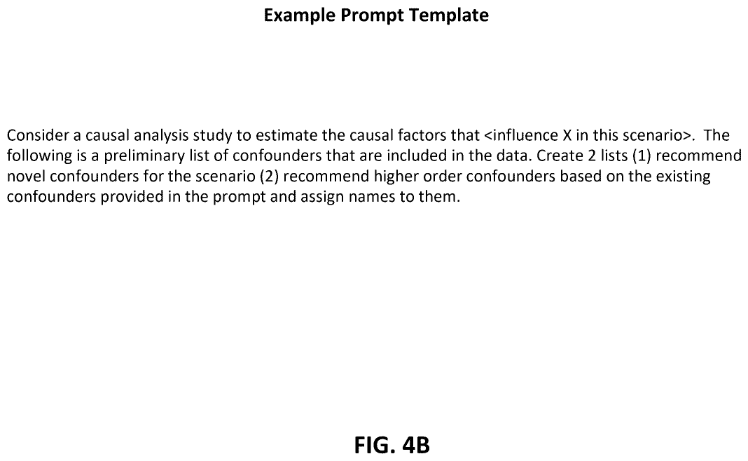

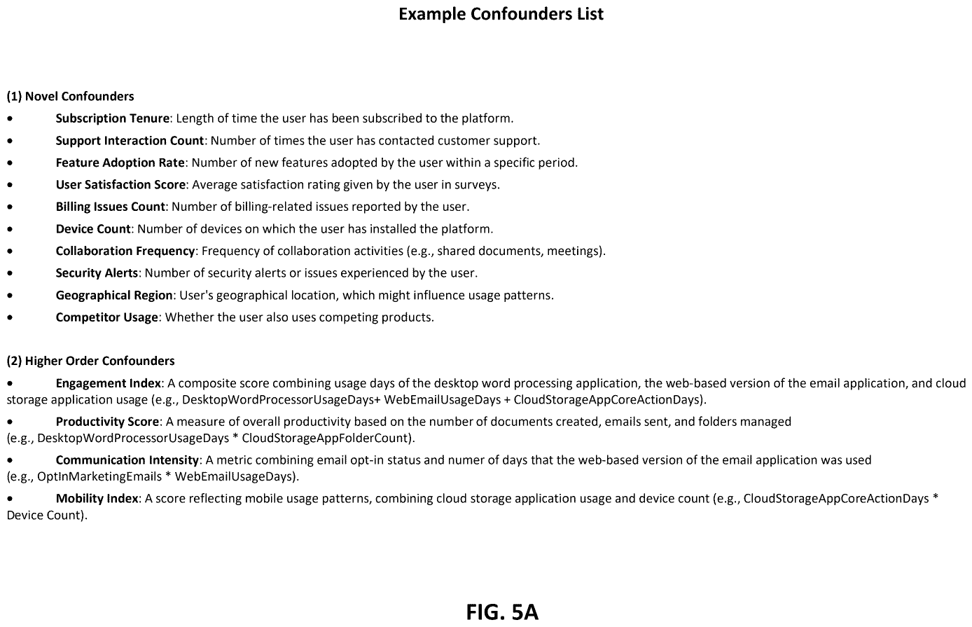

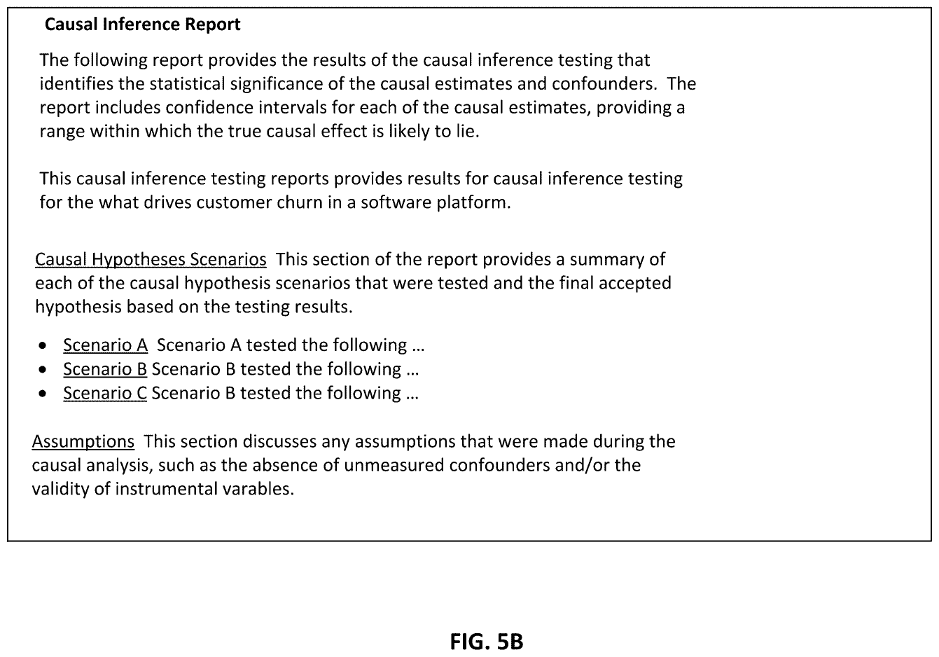

The process 100 includes an operation 104 in which the automated confounder generation framework constructs a prompt for a large language model that instructs the large language model to analyze the metadata and to generate a preliminary list of candidate causal confounders. An example of such a prompt is shown in FIG. 4A. In this example, the prompt instructs the large language model to analyze the metadata and to generate a two-part list of confounders: (1) novel confounders for the scenario, and (2) higher-order confounders based on the exiting confounders provided in the prompt and assign names to these higher-order confounders. The novel confounders include causal confounders that were not expressly identified in the metadata that provided as an input to the model along with the prompt. The higher-order confounders include different combinations of confounders included in the metadata and/or included in the novel confounders identified by the large language model. FIG. 5A provides a non-limiting example of the list of novel and higher-order confounders generated in response to submitting the prompt shown in FIG. 4A and the metadata shown in FIG. 3 as an input to the large language model. The list of novel confounders includes causal confounders that were not identified in the metadata received from the analytics platform but have been inferred by the large language model analyzing the metadata and/or the analytics data received from the analytics platform. The higher-order confounders represent combinations of causal confounders that can influence the outcome. The higher-order confounders are inferred by the large language model from the causal confounders included in the meta data and/or the novel confounders inferred by the large language model. The higher-order confounders represent more complex interactions that can influence the outcome.

FIG. 4B is a diagram of an example template that the automated confounder generation framework uses to generate the prompt shown in FIG. 4A. The template includes placeholder text demarcated by brackets “<>” to indicate that the text included therein should be replaced with text that is application to the causal analysis being performed. In the example shown in FIGS. 4A and 4B, the placeholder text is replaced by the text “drive churn of subscription users” in the prompt that is submitted to the large language model. The text that replaces the placeholder text in the prompt template can be based on a description of the causal inference to be performed that is input by the user in a prompt presented to the user in the analytics platform in response to the user clicking on or otherwise activating a control presented in the analytics platform that initiates the automated confounder generation framework.

The process 100 includes an operation 106 in which the automated confounder generation framework performs feature generation based on the list of confounders output by the large language model. In this feature generation operation, the automated confounder generation framework calculates data values for the novel confounders and the higher-order confounders generated by the large language model. These data values can then be added to the dataset that is available in the analytics platform. These additional data values are then available to both the automated confounder generation framework for additional processing and the analytics platform. The additional data values may be stored in a table, spreadsheet, or other data structure. The specific format of these additional data values depends at least in part on the data formats that the source data obtained from the analytics platform.

The automated confounder generation framework can also be configured to determine that the at least a portion of the data required to determine the values of one or more of the novel confounders and/or the higher-order confounders is unavailable in the dataset being analyzed in the analytics platform and identify an alternative data source for obtaining this data. The automated confounder generation framework can attempt to access the data unavailable in the dataset from one or more other datasets. In some implementations, the additional data may be available in one or more source datasets that were used to populate the dataset in the analytics platform. In such implementations, the automated confounder generation framework can prompt the analytics platform to access these datasets to determine whether the required data is available and/or to provide the automated confounder generation framework with information needed to access these datasets, such as a database or file from which may host the requested data. The automated confounder generation framework can also prompt the user to identify the location of one or more datasets that include the additional data required to determine the values associated with the novel confounders and/or the higher-order confounders. If the data associated with one or more of the novel confounders and/or the higher-order confounders cannot be obtained, the automated confounder generation framework can proceed with the causal analysis without these novel confounders and/or the higher-order confounders and include an indication in the report generated that these novel confounders and/or the higher-order confounders may influence the causal analysis but the data was unavailable to include these novel confounders and/or the higher-order confounders in the causal analysis.

The process 100 includes an operation 108 in which the automated confounder generation framework generates multiple causal hypothesis scenarios. Causal inference is used to determine whether an observed association between a variable and an outcome actually reflects a cause-and-effect relationship. The causal inference hypothesis scenarios consider how different sets of one or more causal confounders influence this cause-and-effect relationship. For instance, referring again to the example prompt shown in FIG. 4A, the causal analysis is performed to determine variables that influence subscription churn, which references to the percentage of users that cancel their subscriptions to a service within a specified period of time. The causal hypothesis scenarios attempt to identify variables, either alone or in combination, that actually reflect a cause-and-effect relationship that influence users who cancel their subscriptions, as well as impact of potential confounders on this outcome. The automated confounder generation framework constructs causal hypothesis scenarios that include one or more causal confounders from the metadata, one or more of the novel confounders identified by the large language model, and/or one or more of the higher-order confounders identified by the large language model. A technical benefit of this approach is that the automated confounder generation framework can generate and test an exhaustive set of causal hypotheses that would be impractical or impossible for a human user to generate and test.

The process 100 includes an operation 110 in which the automated confounder generation framework tests the causal hypothesis scenarios to obtain causal inference results. The automated confounder generation framework implements a causal inference estimator that applies various causal inference techniques to test each of the causal hypothesis scenarios generated in operation 108 to estimate the impact of each of the confounders and/or combination thereof on the outcome. These causal inference methods can include but are not limited to one or more of double machine learning, propensity score matching, instrumental variables, and/or regression discontinuity. The causal inference methods utilize data included in the analytics data obtained from the analytics platform and/or the other data that was obtained during feature generation. The results of testing each of the causal hypothesis scenarios is an estimated causal effect of each confounder or combination of confounders. The causal effect indicates a change in the outcome that is attributable to the confounder or combination of confounders. The automated confounder generation framework can also apply multiple techniques to each of the causal hypothesis scenarios to estimate the causal effects under different scenarios.

The process 100 includes an operation 112 in which the automated confounder generation framework performs statistical testing on the causal inference results obtained from operation 110 to iteratively prune the list of confounders to eliminate confounders that do not satisfy a significance threshold. The automated confounder generation framework performs significance testing to evaluate the significance of each confounder using statistical tests and causal inference techniques. In operation 112, the automated confounder generation framework uses significance testing to assess how much each confounder affects the estimated causal effects determined in operation 110. The automated confounder generation framework can utilize various significant testing techniques and is not limited to a particular significance testing technique. The automated confounder generation framework can assess whether each of the confounders satisfies a significance threshold. The significant threshold indicates whether the confounder has a substantial impact on the estimate causal effects determined in operation 110. The specific threshold utilized can vary from implementation to implementation and may depend at least in part on the statistical testing methods utilized by the automated confounder generation framework. The automated confounder generation framework prunes those confounders that do not satisfy the significance threshold to generate the pruned list of confounders.

The process 100 includes an operation 114 in which the automated confounder generation framework can return to operation 104 to utilize the large language model to generate second higher-order confounder features through feature engineering. The second higher-order features are combinations or transformations selected from among one or more of the original confounders included in the metadata, the one or more novel confounders identified by the language model, and the one or more first higher-order confounders identified by the language model. For instance, the higher-order features can include but are not limited to interaction terms and/or polynomial features. Interaction terms are terms in regression models that show how the effect of one variable depends on the value of another variable. The interaction terms can be used to improve the fit of the model to data by making the model more flexible, which can significantly improve the predictive performance of the model. Interaction terms can be created by multiplying two or more independent variables. Each variable of the interaction term is associated with a coefficient that represents how much the effect of that variable impacts the outcome. Polynomial features refers to a technique in which existing features are raised to different powers and analyzed to capture relationships between the variables that may not be apparent with only the original features. For instance, a particular feature may be squared, cubed, or raised to a different power to create new features that represent higher-order relationship between a variable and the outcome. This approach can be used to create a polynomial curve that can provide better representation of a complex relationship between a feature and the output than a representation provided by a linear model. The automated confounder generation framework can also multiply the polynomial features together to create interaction terms. The automated confounder generation framework perform the loop including operations 114, 104, 106, 108, and 110 until no additional higher-order confounders can be created.

The process 100 includes an operation 116 in which the automated confounder generation framework generates a report. The report is a comprehensive discussion of the confounders that have been identified by the automated confounder generation framework. The report discusses the statistical significance of causal estimates and the confounders. The report also includes confidence intervals for each of the causal estimates. The confidence intervals provide a range within which the true causal effect is likely to lie. The report also includes the hypothesis scenarios that we tested and the final accepted hypothesis from among the hypothesis scenarios that were tested. The report also includes a discussion of any assumptions that were made during the causal analysis, such as but not limited to the absence of unmeasured confounders or the validity of the instrumental variables. FIG. 5B provides an example report for the example metadata shown in FIG. 3, the prompt shown in FIG. 4A, and the lists of causal confounders shown in FIG. 5A. The specific details and format of the report can vary in different implementations. The contents and format of the report are not limited to the example shown in FIG. 5B. In the examples shown in FIG. 5B, the report is presented on a user interface of the analytics platform.

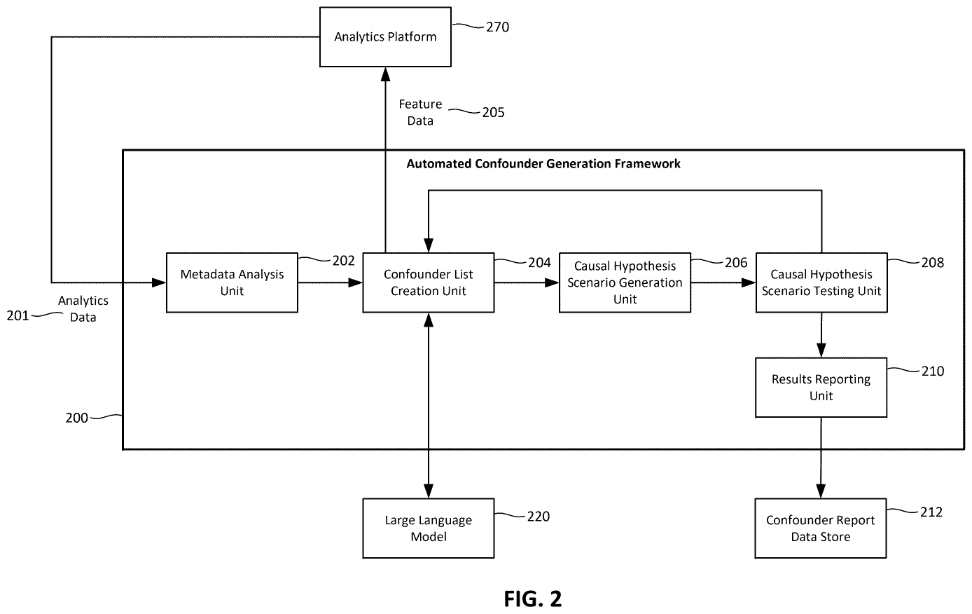

FIG. 2 is a diagram of an example automated confounder generation framework 200 that can implement the process 100 shown in FIG. 1. The automated confounder generation framework 200 includes a metadata analysis unit 202. The metadata analysis unit 202 receives the analytics data and metadata 201 from the analytics platform 270. As discussed above, the automated confounder generation framework 200 can be integrated into the analytics platform 270 and can provide a control, which when activated, causes the analytics platform to provide the analytics data and the associated metadata to the automated confounder generation framework 200. The automated confounder generation framework 200 can be implemented at least in part on the client device of a user or may be implemented on a cloud-based system. Furthermore, certain features of the automated confounder generation framework 200 may be implemented on the client device of the user while other features of the automated confounder generation framework 200 are implemented by the client device.

The metadata analysis unit 202 performs operation 102 of the process 100 shown in FIG. 1. The metadata analysis unit 202 receives metadata that describes the characteristics and properties of the input data from the analytics platform 270. These characteristics and properties include a structure of the input data. The data can include various types of data on which causal analysis is to be performed. For instance, the metadata may include various information, such as but not limited column names, data types, and descriptions of the analytics data. The metadata analysis unit 202 can reformat the metadata into a standardized format utilized by the automated confounder generation framework 200.

The metadata analysis unit 202 provides the metadata to the confounder list creation unit 204. The confounder list creation unit 204 performs the operation 104 of the process 100 shown in FIG. 1. The confounder list creation unit 204 constructs a prompt to the large language model 220 instructing the large language model 220 to generate a list of confounders based on the metadata. FIG. 4A provides an example of such a prompt, and FIG. 4B provides an example of a prompt template that the confounder list creation unit 204 can use to generate the prompt. The prompt template can be stored in a persistent memory of the client device and/or the cloud-based system on which the automated confounder generation framework 200 has been implemented. The confounder list creation unit 204 provides the metadata and the prompt to the large language model 220 as an input and receives the list of confounders as an output of the prompt. As discussed with respect to FIG. 1, the list of confounders can include multiple types of confounders. For instance, the list of confounders can include both novel confounders and higher-order confounders that have been identified by the large language model 220.

The confounder list creation unit 204 also performs operation 106 of the process 100 shown in FIG. 1. The confounder list creation unit 204 performs feature generation based on the list of confounders. In this feature generation operation, the confounder list creation unit 204 calculates data values for the novel confounders and the higher-order confounders generated by the large language model. These data values can then be output as feature data 205, which can then be added to the dataset available in the analytics platform 270. The additional data values may be stored in a table, spreadsheet, or other data structure. The specific format of these additional data values depends at least in part on the data formats that the source data obtained from the analytics platform.

The confounder list creation unit 204 provides the list of confounders as an input to the causal hypothesis scenario generation unit 206. The causal hypothesis scenario generation unit 206 performs operation 108 of the process 100 shown in FIG. 1. As discussed in the preceding examples, the causal hypothesis scenario generation unit 206 constructs causal hypothesis scenarios that include one or more causal confounders from the metadata, one or more of the novel confounders identified by the large language model, and/or one or more of the higher-order confounders identified by the large language model.

The causal hypothesis scenario generation unit 206 provides the causal hypothesis scenarios as an input to the causal hypothesis scenario testing unit 208. The causal hypothesis scenario testing unit 208 implements the operation 110 to test the causal hypothesis scenarios. As discussed in the preceding examples, the causal hypothesis scenario testing unit 208 implements a causal inference estimator that applies various causal inference methods to test each of the causal hypothesis scenarios generated by the causal hypothesis scenario generation unit 206. The causal hypothesis scenario testing unit 208 also implements the operation 112 in which the automated confounder generation framework performs statistical testing on the results obtained from operation 110 to prune the list of confounders to eliminate confounders that do not satisfy a significance threshold. The causal hypothesis scenario testing unit 208 can also perform operation 114 in which the automated confounder generation framework can return to operation 104 to utilize the large language model to generate higher-order confounder features through feature engineering. If the causal hypothesis scenario generation unit 206 cannot identify any further higher-order confounder features, the causal hypothesis scenario testing unit 208 provides an indication to the results reporting unit 210 to perform operation 116 of the process 100 to generate the report that provides a comprehensive discussion of the confounders that have been identified. The report generated by the results reporting unit 210 can be stored in the confounder report data store 212. The results reporting unit 210 can also store the analytics data and metadata 201, the confounder list, causal hypothesis scenarios, the results of testing the causal hypothesis scenarios, and/or other data used or generated by the automated confounder generation framework 200 in the confounder report data store 212.

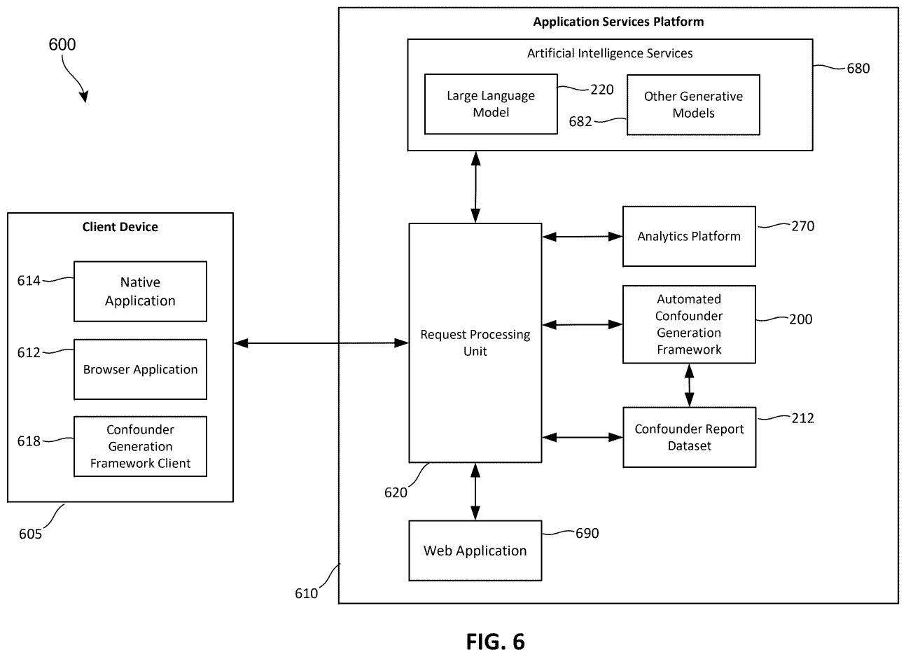

FIG. 6 is a diagram of an example computing environment 600 in which the techniques for large language model inferred causal confounder generation disclosed herein are implemented. The example computing environment 600 includes a client device 605 and an application services platform 610. The application services platform 610 provides the analytics platform 270 discussed in the preceding examples. The analytics platform 270 can provide tools for inputting data, data management, data analysis, data visualization, and reporting. At least a portion of the functionality of the analytics platform 270 can also be implemented on the client device 605. For instance, the native application 614 of the client device can implement at least a portion of the functionality of the analytics platform 270. The application services platform 610 can also provide one or more cloud-based application and/or services that support one or more web-enabled native applications on the client device 605. These applications may include but are not limited to word processing applications, database applications, spreadsheet applications, design applications, communications platforms, visualization tools, and collaboration tools for collaboratively creating visual representations of information, and other applications for consuming and/or creating electronic content. The client device 605 and the application services platform 610 communicate with each other over a network (not shown). The network may be a combination of one or more public and/or private networks and may be implemented at least in part by the Internet.

The automated confounder generation framework 200 implements the process shown in FIG. 1 for automatically identifying confounders. An example implementation of the automated confounder generation framework 200 is shown in FIG. 2. The automated confounder generation framework 200 integrates with the analytics platform 270. The client device 605 can include one or more native applications, such as the native application 614, which can include one or more applications that implement at least a portion of the functionality of the analytics platform 270 on the client device 605 and/or are web-applications that access content and/or services provided by the analytics platform 270. The client device 605 can also access the services and/or content provided by the analytics platform 270 via the web application 690. The client device 605 can access the web application 690 via the browser application 612. Some implementations of the client device 605 can include a confounder generation framework client 618, which implements the functionality that integrates the automated confounder generation framework 200 with native application or native applications on the client device that implement at least a portion of the functionality of the analytics platform 270. For example, the confounder generation framework client 618 may be an add-on or extension that integrates the functionality of the automated confounder generation framework with the analytics platform.

The request processing unit 620 receives requests from an application implemented by the native application 614 of the client device 605 and/or the web application 690 of the application services platform 610. The native application 614 and/or the web application 690 provide one or more user interfaces that enables users to view, create, and/or modify electronic content. The request processing unit 620 can receive requests from the native application 614 and/or the web application 690 to cause the automated confounder generation framework 200 to analyze analytics data to identify confounders according to the techniques disclosed herein. The request processing unit 620 also coordinates communication and exchange of data among components of the application services platform 610 as discussed in the examples which follow. The request processing unit 620 can also receive requests to access the confounder report data store 212 to obtain data stored therein and to provide the data to the native application 614 and/or the web application 690. As discussed in the preceding examples, the automated confounder generation framework 200 can store report data, analytics data on which the report is based, the confounder list generated using the large language model 220, causal hypothesis scenarios, the results of testing the causal hypothesis scenarios, and/or other data used or generated by the automated confounder generation framework 200.

The artificial intelligence (AI) services 680 provide various machine learning models that analyze and/or generate content. The AI services 680 includes a large language model 220. The large language model (LLM) is an artificial neural network characterized by the size of the model. For instance, an LLM may include a billion or even a trillion weights. The large language model 220 is implemented by a Generative Pre-Trained Transformer (GPT) language model in some implementations. Other types of AI models that are capable of generating image content in response to a textual prompt can be utilized in other implementations. The large language model 220 is used by the automated confounder generation framework 200 to generate lists of confounders based on the analytics data and/or metadata obtained from the analytics platform 270. The large language model 220 can also be used to generate a textual response to other types of prompts constructed by the native application 614, the web application 690, and/or by components of the application services platform 610.

The AI services 680 can also include other generative models 682. The other generative models can include artificial intelligence models that are capable of generating audio, video, images, various types of documents, and/or other types of content. In some implementations, the large language model 220 can implement the functionality of the other generative models 682. The other generative models can be implemented utilizing various model architectures. Some models may be implemented using a GPT language model architecture, while other models may be implemented using other model architectures. The other generative models 682 can be used to generate content in response to prompts constructed by the native application 614, the web application 690, and/or by components of the application services platform 610.

The client device 605 is a computing device that may be implemented as a portable electronic device, such as a mobile phone, a tablet computer, a laptop computer, a portable digital assistant device, a portable game console, and/or other such devices in some implementations. The client device 605 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 6 includes a single client device, other implementations may include a different number of client devices that utilize services provided by the application services platform 610.

The client device 605 includes a native application 614 and a browser application 612. The native application 614 is a web-enabled native application, in some implementations, that enables users to view, create, and/or modify electronic content. The web-enabled native application utilizes services provided by the application services platform 610 including but not limited to creating, viewing, and/or modifying various types of electronic content. The native application 614 can utilize the application services platform 610 to generate various types of content in response to user prompts, to analyze analytics data, to perform causal analysis on the analytics data, and/or identify confounders in the analytics data. In other implementations, the browser application 612 is used for accessing and viewing web-based content provided by the application services platform 610. In such implementations, the application services platform 610 implements one or more web applications, such as the web application 690, that enables users to view, create, and/or modify electronic content. The web application 690 can utilize the application services platform 610 to generate various types of content in response to user prompts, to analyze analytics data, to perform causal analysis on the analytics data, and/or identify confounders in the analytics data. The application services platform 610 supports both web-enabled native applications and a web application in some implementations, and the users may choose which approach best suits their needs.

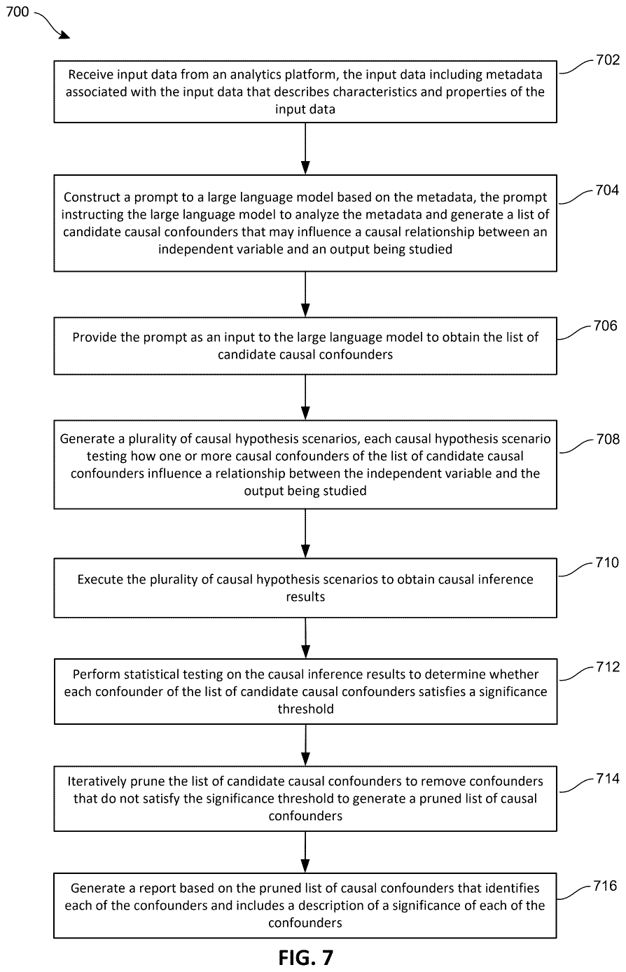

FIG. 7 is a flow chart of an example process 700 for automatically identifying causal confounders according to the techniques disclosed herein. The process 700 can be implemented by the application services platform 610 and/or the automated confounder generation framework 200 discussed in the preceding examples.

The process 700 includes an operation 702 of receiving input data from an analytics platform, the input data including metadata associated with the input data that describes characteristics and properties of the input data. The metadata describes the characteristics and properties of the input data from the analytics platform. These characteristics and properties include a structure of the input data. The data can include various types of data on which causal analysis is to be performed. The metadata analysis unit 202 receives the input data and the metadata from the analytics platform 270. The metadata may include various information, such as but not limited column names, data types, and descriptions of the analytics data. The metadata analysis unit 202 can reformat the metadata into a standardized format utilized by the automated confounder generation framework 200.

The process 700 includes an operation 704 of constructing a prompt to a large language model based on the metadata, the prompt instructing the large language model to analyze the metadata and generate a list of candidate causal confounders that may influence a causal relationship between an independent variable and an output being studied and an operation 706 of providing the prompt as an input to the large language model to obtain the list of candidate causal confounders. The confounder list creation unit 204 constructs a prompt to the large language model 220 instructing the large language model 220 to generate a list of confounders based on the metadata and provides the prompt as an input to the large language model 220 to obtain the list of candidate causal confounders. The prompt can instruct the large language model to analyze the metadata and to generate a two-part list of confounders: (1) novel confounders for the scenario, and (2) higher-order confounders based on the exiting confounders provided in the prompt and assign names to these higher-order confounders.

The process 700 includes an operation 708 of generating a plurality of causal hypothesis scenarios, each causal hypothesis scenario testing how one or more causal confounders of the list of candidate causal confounders influence a relationship between the independent variable and the output being studied. The causal hypothesis scenario generation unit 206 constructs causal hypothesis scenarios that include one or more causal confounders from the metadata, one or more of the novel confounders identified by the large language model, and/or one or more of the higher-order confounders identified by the large language model.

The process 700 includes an operation 710 of executing the plurality of causal hypothesis scenarios to obtain causal inference results. The causal hypothesis scenario testing unit 208 implements the operation 110 to test the causal hypothesis scenarios. As discussed in the preceding examples, the causal hypothesis scenario testing unit 208 implements a causal inference estimator that applies various causal inference methods to test each of the causal hypothesis scenarios generated by the causal hypothesis scenario generation unit 206.

The process 700 includes an operation 712 of performing statistical testing on the causal inference results to determine whether each confounder of the list of candidate causal confounders satisfies a significance threshold and an operation 714 of iteratively pruning the list of candidate causal confounders to remove confounders that do not satisfy the significance threshold to generate a pruned list of causal confounders. The causal hypothesis scenario testing unit 208 also performs statistical testing on the results obtained from operation 110 to prune the list of candidate confounders to eliminate confounders that do not satisfy a significance threshold.

The process 700 includes an operation 716 of generating a report based on the pruned list of causal confounders that identifies each of the confounders and includes a description of a significance of each of the confounders. The results reporting unit 210 generates the report that provides a comprehensive discussion of the confounders that have been identified. The report generated by the results reporting unit 210 can be stored in the confounder report data store 212. The results reporting unit 210 can also store the analytics data and metadata 201, the confounder list, causal hypothesis scenarios, the results of testing the causal hypothesis scenarios, and/or other data used or generated by the automated confounder generation framework 200 in the confounder report data store 212.

The detailed examples of systems, devices, and techniques described in connection with FIGS. 1-7 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-7 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

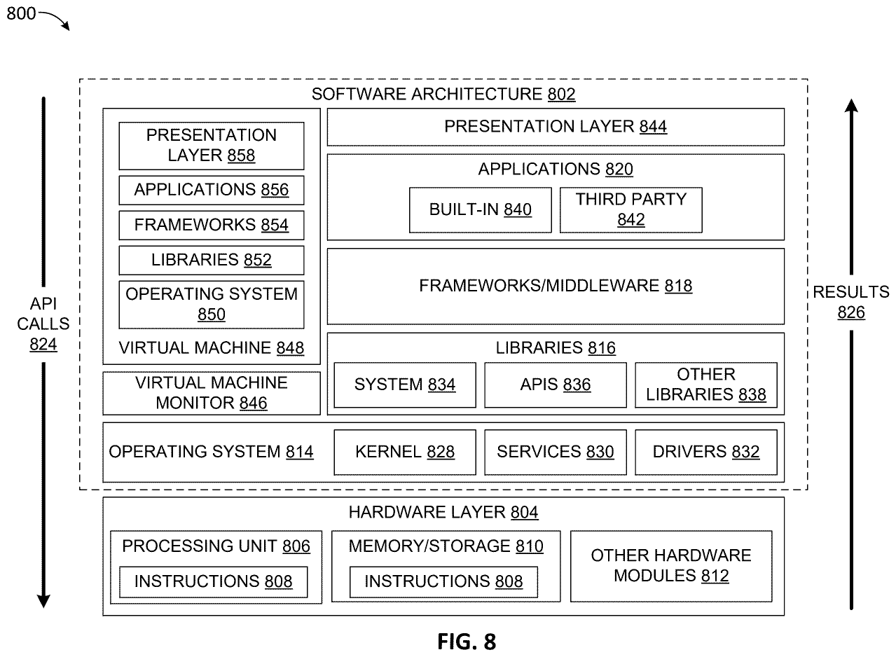

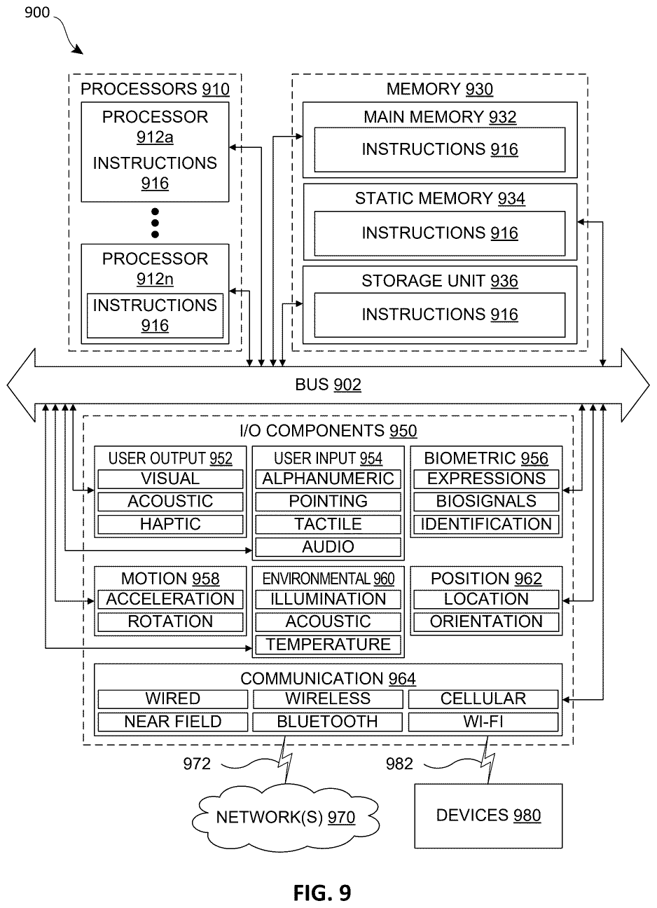

FIG. 8 is a block diagram 800 illustrating an example software architecture 802, various portions of which may be used in conjunction with various hardware architectures herein described, which may implement any of the above-described features. FIG. 8 is a non-limiting example of a software architecture, and it will be appreciated that many other architectures may be implemented to facilitate the functionality described herein. The software architecture 802 may execute on hardware such as a machine 900 of FIG. 9 that includes, among other things, processors 910, memory/storage, and input/output (I/O) components 950. A representative hardware layer 804 is illustrated and can represent, for example, the machine 900 of FIG. 9. The representative hardware layer 804 includes a processing unit 806 and associated executable instructions 808. The executable instructions 808 represent executable instructions of the software architecture 802, including implementation of the methods, modules and so forth described herein. The hardware layer 804 also includes a memory/storage 810, which also includes the executable instructions 808 and accompanying data. The hardware layer 804 may also include other hardware modules 812. Instructions 808 held by processing unit 806 may be portions of instructions 808 held by the memory/storage 810.

The example software architecture 802 may be conceptualized as layers, each providing various functionality. For example, the software architecture 802 may include layers and components such as an operating system (OS) 814, libraries 816, frameworks/middleware 818, applications 820, and a presentation layer 844. Operationally, the applications 820 and/or other components within the layers may invoke API calls 824 to other layers and receive corresponding results 826. The layers illustrated are representative in nature and other software architectures may include additional or different layers. For example, some mobile or special purpose operating systems may not provide the frameworks/middleware 818.

The OS 814 may manage hardware resources and provide common services. The OS 814 may include, for example, a kernel 828, services 830, and drivers 832. The kernel 828 may act as an abstraction layer between the hardware layer 804 and other software layers. For example, the kernel 828 may be responsible for memory management, processor management (for example, scheduling), component management, networking, security settings, and so on. The services 830 may provide other common services for the other software layers. The drivers 832 may be responsible for controlling or interfacing with the underlying hardware layer 804. For instance, the drivers 832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 816 may provide a common infrastructure that may be used by the applications 820 and/or other components and/or layers. The libraries 816 typically provide functionality for use by other software modules to perform tasks, rather than interacting directly with the OS 814. The libraries 816 may include system libraries 834 (for example, C standard library) that may provide functions such as memory allocation, string manipulation, file operations. In addition, the libraries 816 may include API libraries 836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 816 may also include a wide variety of other libraries 838 to provide many functions for applications 820 and other software modules.

The frameworks/middleware 818 provide a higher-level common infrastructure that may be used by the applications 820 and/or other software modules. For example, the frameworks/middleware 818 may provide various graphic user interface (GUI) functions, high-level resource management, or high-level location services. The frameworks/middleware 818 may provide a broad spectrum of other APIs for applications 820 and/or other software modules.

The applications 820 include built-in applications 840 and/or third-party applications 842. Examples of built-in applications 840 may include, but are not limited to, a contacts application, a browser application, a location application, a media application, a messaging application, and/or a game application. Third-party applications 842 may include any applications developed by an entity other than the vendor of the particular platform. The applications 820 may use functions available via OS 814, libraries 816, frameworks/middleware 818, and presentation layer 844 to create user interfaces to interact with users.

Some software architectures use virtual machines, as illustrated by a virtual machine 848. The virtual machine 848 provides an execution environment where applications/modules can execute as if they were executing on a hardware machine (such as the machine 900 of FIG. 9, for example). The virtual machine 848 may be hosted by a host OS (for example, OS 814) or hypervisor, and may have a virtual machine monitor 846 which manages operation of the virtual machine 848 and interoperation with the host operating system. A software architecture, which may be different from software architecture 802 outside of the virtual machine, executes within the virtual machine 848 such as an OS 850, libraries 852, frameworks 854, applications 856, and/or a presentation layer 858.

FIG. 9 is a block diagram illustrating components of an example machine 900 configured to read instructions from a machine-readable medium (for example, a machine-readable storage medium) and perform any of the features described herein. The example machine 900 is in a form of a computer system, within which instructions 916 (for example, in the form of software components) for causing the machine 900 to perform any of the features described herein may be executed. As such, the instructions 916 may be used to implement modules or components described herein. The instructions 916 cause unprogrammed and/or unconfigured machine 900 to operate as a particular machine configured to carry out the described features. The machine 900 may be configured to operate as a standalone device or may be coupled (for example, networked) to other machines. In a networked deployment, the machine 900 may operate in the capacity of a server machine or a client machine in a server-client network environment, or as a node in a peer-to-peer or distributed network environment. Machine 900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 900 is illustrated, the term “machine” includes a collection of machines that individually or jointly execute the instructions 916.

The machine 900 may include processors 910, memory/storage 930, and I/O components 950, which may be communicatively coupled via, for example, a bus 902. The bus 902 may include multiple buses coupling various elements of machine 900 via various bus technologies and protocols. In an example, the processors 910 (including, for example, a central processing unit (CPU), a graphics processing unit (GPU), a digital signal processor (DSP), an ASIC, or a suitable combination thereof) may include one or more processors 912a to 912n that may execute the instructions 916 and process data. In some examples, one or more processors 910 may execute instructions provided or identified by one or more other processors 910. The term “processor” includes a multicore processor including cores that may execute instructions contemporaneously. Although FIG. 9 shows multiple processors, the machine 900 may include a single processor with a single core, a single processor with multiple cores (for example, a multicore processor), multiple processors each with a single core, multiple processors each with multiple cores, or any combination thereof. In some examples, the machine 900 may include multiple processors distributed among multiple machines.

The memory/storage 930 may include a main memory 932, a static memory 934, or other memory, and a storage unit 936, both accessible to the processors 910 such as via the bus 902. The storage unit 936 and memory 932, 934 store instructions 916 embodying any one or more of the functions described herein. The memory/storage 930 may also store temporary, intermediate, and/or long-term data for processors 910. The instructions 916 may also reside, completely or partially, within the memory 932, 934, within the storage unit 936, within at least one of the processors 910 (for example, within a command buffer or cache memory), within memory at least one of I/O components 950, or any suitable combination thereof, during execution thereof. Accordingly, the memory 932, 934, the storage unit 936, memory in processors 910, and memory in I/O components 950 are examples of machine-readable media.

As used herein, “machine-readable medium” refers to a device able to temporarily or permanently store instructions and data that cause machine 900 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 916) for execution by a machine 900 such that the instructions, when executed by one or more processors 910 of the machine 900, cause the machine 900 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 950 may include a wide variety of hardware components adapted to receive input, provide output, produce output, transmit information, exchange information, capture measurements, and so on. The specific I/O components 950 included in a particular machine will depend on the type and/or function of the machine. For example, mobile devices such as mobile phones may include a touch input device, whereas a headless server or IoT device may not include such a touch input device. The particular examples of I/O components illustrated in FIG. 9 are in no way limiting, and other types of components may be included in machine 900. The grouping of I/O components 950 are merely for simplifying this discussion, and the grouping is in no way limiting. In various examples, the I/O components 950 may include user output components 952 and user input components 954. User output components 952 may include, for example, display components for displaying information (for example, a liquid crystal display (LCD) or a projector), acoustic components (for example, speakers), haptic components (for example, a vibratory motor or force-feedback device), and/or other signal generators. User input components 954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 950 may include biometric components 956, motion components 958, environmental components 960, and/or position components 962, among a wide array of other physical sensor components. The biometric components 956 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 958 may include, for example, acceleration sensors (for example, an accelerometer) and rotation sensors (for example, a gyroscope). The environmental components 960 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 962 may include, for example, location sensors (for example, a Global Position System (GPS) receiver), altitude sensors (for example, an air pressure sensor from which altitude may be derived), and/or orientation sensors (for example, magnetometers).

The I/O components 950 may include communication components 964, implementing a wide variety of technologies operable to couple the machine 900 to network(s) 970 and/or device(s) 980 via respective communicative couplings 972 and 982. The communication components 964 may include one or more network interface components or other suitable devices to interface with the network(s) 970. The communication components 964 may include, for example, components adapted to provide wired communication, wireless communication, cellular communication, Near Field Communication (NFC), Bluetooth communication, Wi-Fi, and/or communication via other modalities. The device(s) 980 may include other machines or various peripheral devices (for example, coupled via USB).

In some examples, the communication components 964 may detect identifiers or include components adapted to detect identifiers. For example, the communication components 964 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 964, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
receiving input data from an analytics platform, the input data including metadata associated with the input data that describes characteristics and properties of the input data;
constructing a prompt to a large language model based on the metadata, the prompt instructing the large language model to analyze the metadata and generate a list of candidate causal confounders that may influence a causal relationship between an independent variable and an output being studied;
providing the prompt as an input to the large language model to obtain the list of candidate causal confounders;
generating a plurality of causal hypothesis scenarios, each causal hypothesis scenario testing how one or more causal confounders of the list of candidate causal confounders influence a relationship between the independent variable and the output being studied;
executing the plurality of causal hypothesis scenarios to obtain causal inference results;
performing statistical testing on the causal inference results to determine whether each confounder of the list of candidate causal confounders satisfies a significance threshold;
iteratively pruning the list of candidate causal confounders to remove confounders that do not satisfy the significance threshold to generate a pruned list of causal confounders; and
generating a report based on the pruned list of causal confounders that identifies each of the confounders and includes a description of a significance of each of the confounders.

2. The data processing system of claim 1, wherein to construct the prompt to the large language model, the memory further includes instructions that, when executed, cause the processor alone or in combination with other processors to perform operations of:
constructing the prompt to the large language model instructing the large language model to identify one or more novel confounders not included in the metadata.

3. The data processing system of claim 2, wherein to construct the prompt to the large language model, the memory further includes instructions that, when executed, cause the processor alone or in combination with other processors to perform operations of:
constructing the prompt to a large language model instructing the large language model to identify one or more first higher-order confounders based on a combination of one or more causal confounders included in the metadata, one or more novel confounders, or both.

4. The data processing system of claim 3, wherein the memory further stores executable instructions that, when executed, cause the processor alone or in combination with other processors to perform operations of:
generating one or more second higher-order confounders by combining two or more confounders selected from among one or more causal confounders included in the metadata, the one or more novel confounders, and the one or more first higher-order confounders.

5. The data processing system of claim 4, wherein the memory further stores executable instructions that, when executed, cause the processor alone or in combination with other processors to perform operations of:
generating a plurality of second causal hypothesis scenarios based on the one or more second higher-order confounders, each second causal hypothesis scenario testing considering how the one or more second higher-order confounders influence a relationship between the independent variable and the output being studied;
executing the plurality of second causal hypothesis scenarios to obtain second causal inference results;
performing statistical testing on the second causal inference results to determine whether the one or more second higher-order confounders satisfy the significance threshold;
pruning the one or more second higher-order confounders to remove higher-order confounders that do not satisfy the significance threshold from the one or more second higher-order confounders; and
adding the one or more second higher-order confounders to the list of candidate causal confounders.

6. The data processing system of claim 5, wherein the one or more second higher-order confounders comprise interaction terms, polynomial features, or both.

7. The data processing system of claim 1, wherein the large language model is a Generative Pre-Trained Transformer language model.

8. The data processing system of claim 1, wherein the memory further stores executable instructions that, when executed, cause the processor alone or in combination with other processors to perform operations of:
performing feature generation on the list of candidate causal confounders to generate data values for each confounder in the list of candidate causal confounders based on the input data received from the analytics platform.

9. The data processing system of claim 8, wherein the memory further stores executable instructions that, when executed, cause the processor alone or in combination with other processors to perform operations of:
determining that at least a portion of data required to generate data values for a respective confounder in the list of candidate causal confounders is unavailable in the input data received from the analytics platform;
identifying an alternate source of the data required to generate a value for the respective confounder;
obtaining the data from the alternate source of data; and
generating the data values for the respective confounder.

10. The data processing system of claim 1, wherein to execute the plurality of causal hypothesis scenarios to obtain causal inference results, the memory further includes instructions that, when executed, cause the processor alone or in combination with other processors to perform operations of:
executing, for each causal hypothesis scenario, one or more causal inference methods selected from among double machine learning, propensity score matching, instrumental variables, and regression discontinuity.

11. The data processing system of claim 1, wherein the memory further stores executable instructions that, when executed, cause the processor alone or in combination with other processors to perform operations of:
receiving the input data from the analytics platform in response to a control associated with an automated confounder generation framework being activated in response to a user input.

12. The data processing system of claim 1, wherein the memory further stores executable instructions that, when executed, cause the processor alone or in combination with other processors to perform operations of:
storing the report in a confounder report data store in response to generating the report.

13. The data processing system of claim 1, wherein the memory further stores executable instructions that, when executed, cause the processor alone or in combination with other processors to perform operations of:
presenting the report on a user interface of the analytics platform responsive to generating the report.

14. A method implemented in a data processing system for performing causal analysis, the method comprising:
receiving input data from an analytics platform, the input data including metadata associated with the input data that describes characteristics and properties of the input data;
constructing a prompt to a large language model based on the metadata, the prompt instructing the large language model to analyze the metadata and generate a list of candidate causal confounders that may influence a causal relationship between an independent variable and an output being studied;
providing the prompt as an input to the large language model to obtain the list of candidate causal confounders;
generating a plurality of causal hypothesis scenarios, each causal hypothesis scenario testing how one or more causal confounders of the list of candidate causal confounders influence a relationship between the independent variable and the output being studied;
executing the plurality of causal hypothesis scenarios to obtain causal inference results;
performing statistical testing on the causal inference results to determine whether each confounder of the list of candidate causal confounders satisfies a significance threshold;
iteratively pruning the list of candidate causal confounders to remove confounders that do not satisfy the significance threshold to generate a pruned list of causal confounders; and
generating a report based on the pruned list of causal confounders that identifies each of the confounders and includes a description of a significance of each of the confounders.

15. The method of claim 14, wherein constructing the prompt to the large language model further comprises:
constructing the prompt to a large language model instructing the large language model to identify one or more novel confounders not included in the metadata.

16. The method of claim 15, wherein constructing the prompt to the large language model further comprises:
constructing the prompt to a large language model instructing the large language model to identify one or more first higher-order confounders based on a combination of one or more causal confounders included in the metadata, one or more novel confounders, or both.

17. The method of claim 16, further comprising:
generating one or more second higher-order confounders by combining two or more confounders selected from among one or more causal confounders included in the metadata, the one or more novel confounders, and the one or more first higher-order confounders.

18. The method of claim 17, further comprising:
generating a plurality of second causal hypothesis scenarios based on the one or more second higher-order confounders, each second causal hypothesis scenario testing considering how the one or more second higher-order confounders influence a relationship between the independent variable and the output being studied;
executing the plurality of second causal hypothesis scenarios to obtain second causal inference results;
performing statistical testing on the second causal inference results to determine whether the one or more second higher-order confounders satisfy the significance threshold;
pruning the one or more second higher-order confounders to remove higher-order confounders that do not satisfy the significance threshold from the one or more second higher-order confounders; and
adding the one or more second higher-order confounders to the list of candidate causal confounders.

19. The method of claim 18, wherein the one or more second higher-order confounders comprise interaction terms, polynomial features, or both.

20. A machine-readable medium on which are stored instructions that, when executed, cause a processor of alone or in combination with other processors to perform operations of:
receiving input data from an analytics platform, the input data including metadata associated with the input data that describes characteristics and properties of the input data;
constructing a prompt to a large language model based on the metadata, the prompt instructing the large language model to analyze the metadata and generate a list of candidate causal confounders that may influence a causal relationship between an independent variable and an output being studied;
providing the prompt as an input to the large language model to obtain the list of candidate causal confounders;
generating a plurality of causal hypothesis scenarios, each causal hypothesis scenario testing how one or more causal confounders of the list of candidate causal confounders influence a relationship between the independent variable and the output being studied;
executing the plurality of causal hypothesis scenarios to obtain causal inference results;
performing statistical testing on the causal inference results to determine whether each confounder of the list of candidate causal confounders satisfies a significance threshold;
iteratively pruning the list of candidate causal confounders to remove confounders that do not satisfy the significance threshold to generate a pruned list of causal confounders; and
generating a report based on the pruned list of causal confounders that identifies each of the confounders and includes a description of a significance of each of the confounders.
